(19) United States
(12) Patent Application Publication
(10) Pub. No.: US 2017/0146188 A1
(43) Pub. Date: May 25, 2017

(54) OVERHEAD MOUNTABLE STORAGE SYSTEM

(71) Applicant: LEE MATTSON, Las Vegas, NV (US)

(72) Inventor: LEE MATTSON, Las Vegas, NV (US)

(21) Appl. No.: 14/947,404

(22) Filed: Nov. 20, 2015

(51) Int. Cl. F16M 13/02; A47B 81/00

(52) U.S. Cl. CPC F16M 13/027; A47B 81/00

(57) ABSTRACT

A storage system mountable to a ceiling or other overhead structure. The system having at least two support rails attachable to an overhead member; and at least two storage unit receiving track members configured to movably attach to the at least two support rails in a spaced relationship, the at least two storage unit receiving track members each having a side ledge configured to receive and support an opposite upper portion of one or more storage units comprising a container and lid member wherein opposite upper portions extend into oppositely facing side ledges of the at least two storage unit track members when movably attached to the at least two support rails. A bucket receiving member slidably inserts into the side ledges of the at least two storage unit receiving track members wherein the bucket receiving member is configured to retain buckets such as the ubiquitous 10 gallon bucket.

### FIELD OF THE INVENTION

The embodiments of the present invention relate to a storage system mountable to a ceiling or other overhead structure.

### BACKGROUND

Storage space is often limited in garages due to the fact that individuals desire to park items such as, automobiles, recreational vehicles, boats and the like in garages and other enclosed storage spaces. Accordingly, much of the garage and storage space is occupied by these vehicles and not useful for storage. It is therefore desirous to maximize the utilization of space surrounding the automobiles and other items as mentioned previously, as well as other floor-space and wall-space occupying items. The space above all of these type items is one area of premium suitability for storage if a properly constructed structure is in place.

It would be advantageous to develop a storage system installable on a ceiling or other overhead structure. It would be particular advantageous if the storage system is useable in a garage and other storage spaces if such that the space above automobiles and other type mentioned items is available for storage.

### SUMMARY

One embodiment of the present invention is directed to a system comprising broadly at least two support rails attachable to an overhead member; and at least two storage unit receiving track members configured to movably attach to said at least two support rails in a spaced relationship, said at least two storage unit receiving track members each having a side ledge configured to receive and support an opposite upper portion of one or more storage units comprising a container and lid member wherein opposite upper portions extend into oppositely facing side ledges of said at least two storage unit receiving track members when movably attached to said at least two support rails.

In one embodiment, a bucket receiving member is configured to slidably insert between two storage unit receiving track members for support by said side ledges. Said bucket receiving member is further configured to retain buckets such as the ubiquitous 10 gallon bucket. In one embodiment, the bucket receiving member acts as a clamp about an upper portion of the bucket. The bucket receiving member may accommodate buckets from 1 to 10 gallons or more.

Advantageously, the support rails and storage unit receiving track members are designed such that the storage unit receiving track members may be attached to said support tracks in an angled manner relative to said support rails. Such a relationship is more versatile than a simple orthogonal relationship.

Other variations, embodiments and features of the present invention will become evident from the following detailed description, drawings and claims.

### BRIEF DESCRIPTION OF THE DRAWINGS

FIGS. 1A-1D illustrate storage unit receiving track members according to the embodiments of the present invention;

FIG. 2 illustrates an end view of a storage unit receiving track member according to the embodiments of the present invention;

FIGS. 3A and 3B illustrates support rails attached to a ceiling according to the embodiments of the present invention;

FIG. 4 illustrates an end view of a support rail according to the embodiments of the present invention;

FIGS. 5A-5C illustrate storage unit receiving track members movably attached to support rails according to the embodiments of the present invention;

FIGS. 6A-6E illustrate various storage units hanging from said storage unit receiving track members according to the embodiments of the present invention;

FIGS. 7A and 7B illustrate a bucket receiving member in closed and open positions, respectively, according to the embodiments of the present invention;

FIGS. 8A and 8B illustrate a bucket clamped by said bucket receiving member according to the embodiments of the present invention;

FIG. 9 illustrates a bucket receiving member inserted into the storage unit receiving track members according to the embodiments of the present invention;

FIGS. 10A-10C illustrate an alternative embodiment of said storage unit receiving track members comprising three members according to the embodiments of the present invention; and

FIG. 11 illustrates a wheel for translating storage unit receiving track members according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The embodiments of the present invention, as described below in more detail, involve an overhead storage system comprising broadly a series of support rails attachable to an overhead structure (e.g., ceiling) and a series of storage unit receiving track members movably attachable to said support rails permitting the storage unit receiving track members to slide along the support rails changing the distance between neighboring storage unit receiving track members such that storage units of various sizes can be accommodated. The various components of the storage system detailed herein may be fabricated of any suitable materials including, but not limited to, metals, alloys, composites, woods, plastics, etc., and may be fabricated using any suitable technique including, but not limited to, machining, molding, machining and additive processes.

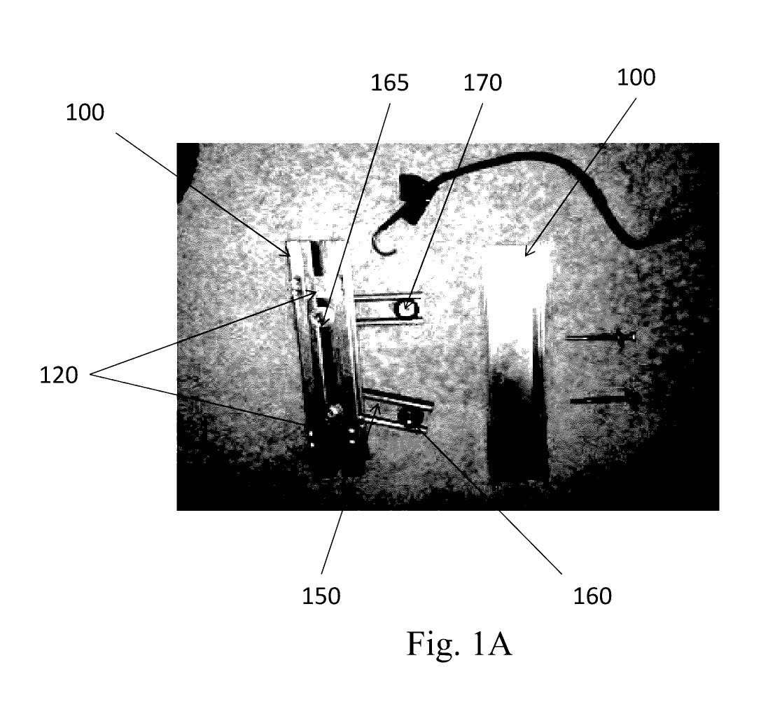

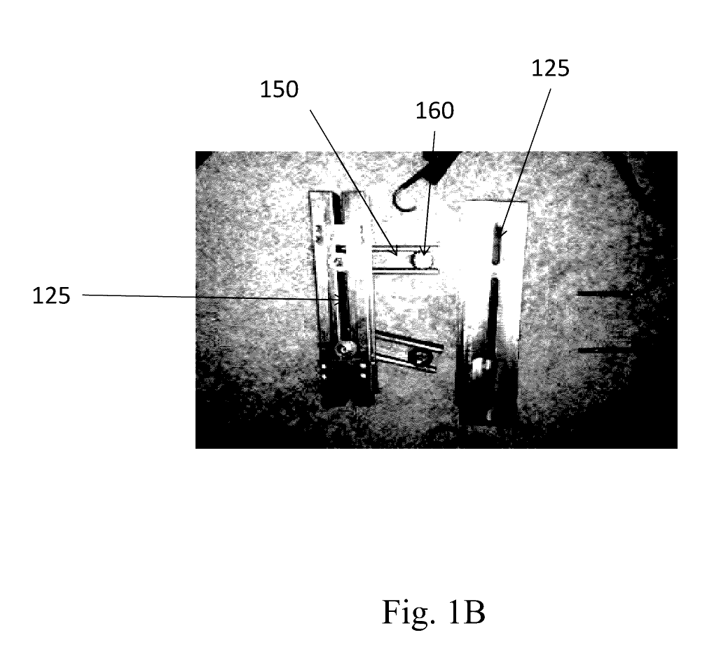

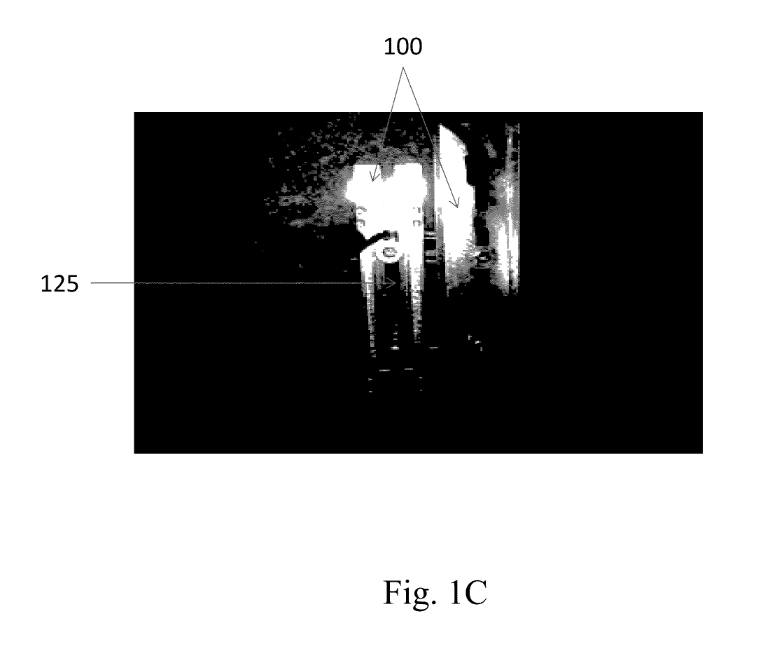

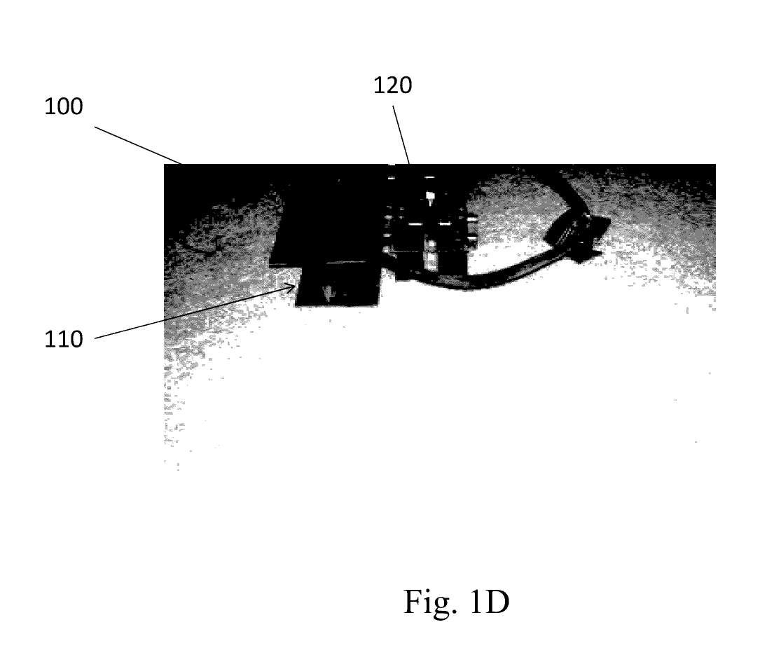

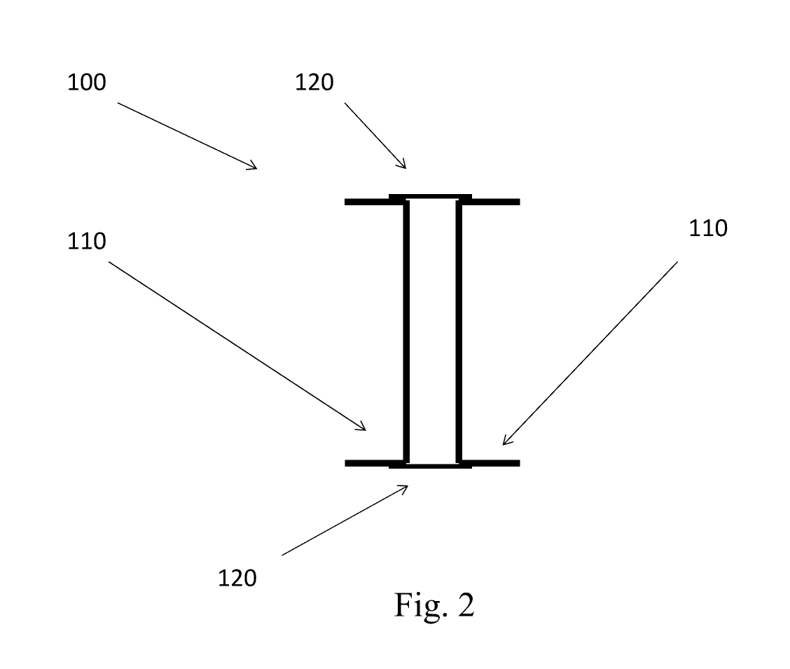

FIGS. 1A-1D and 2 show storage unit receiving track members 100. In one embodiment, the storage unit receiving track members 100 have an I-shaped cross-section. Two lower side ledges 110 serve to receive storage units as detailed below. One or more connector members 120 on the top and bottom hold the two halves together to form the I-shaped cross section. Openings 125 or slots in the top and bottom of the storage unit receiving track members 100 provide a passage for fasteners (e.g., bolts) suitable for movably attaching said storage unit receiving track members 100 to the supports rails 150.

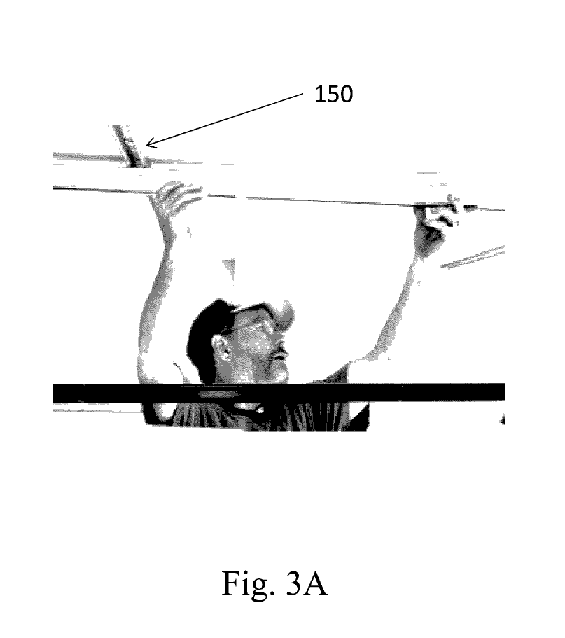

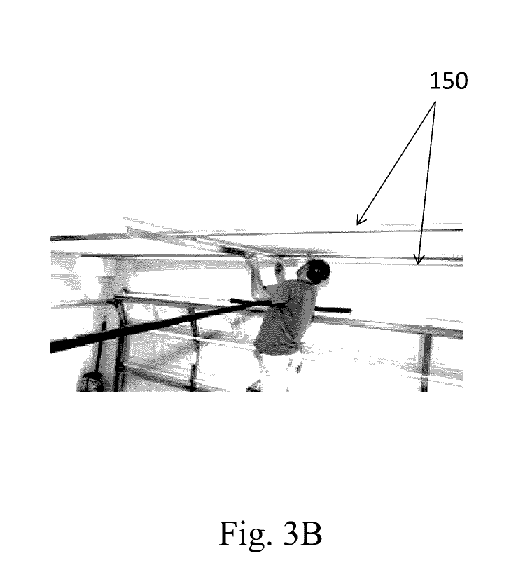

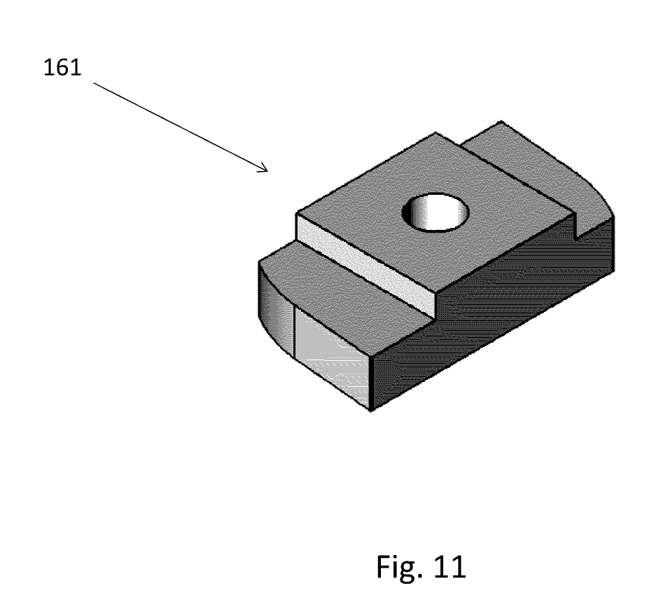

FIGS. 3A and 3B illustrate support rails 150 attached to a ceiling according to the embodiments of the present invention. Attachment of the support rails 150 to the ceiling may be accomplished using any suitable fasteners such as screws, nails, staples, adhesive, etc. The support rails 150 define an internal track 155 configured to receive wheels 160 (see FIGS. 1A and 1B) which are able to translate along the length of the internal track 155. Bolts 165 pass through openings 125 in the top and bottom of the storage unit receiving track members 100 and into the threaded openings 170 in the wheels 160 such that the storage unit receiving track members 100 are able to translate along the length of said internal tracks 155. In this manner, the bolts 165 may be loosened allowing the storage unit receiving track members 100 to slide along the support rails 150 to accommodate storage units of various sizes. Tightening bolts 165 set the storage unit receiving track members 100 at the proper location along the support rails 150. While wheels 160 are described, it is recognized that other articles, such as rollers, bearings and similar roller mechanism may be used to translate the storage unit receiving track members 100 along internal tracks 155. FIG. 11 shows a roller article 161 of the type suitable to translate the storage unit receiving track members 100 along internal tracks 155.

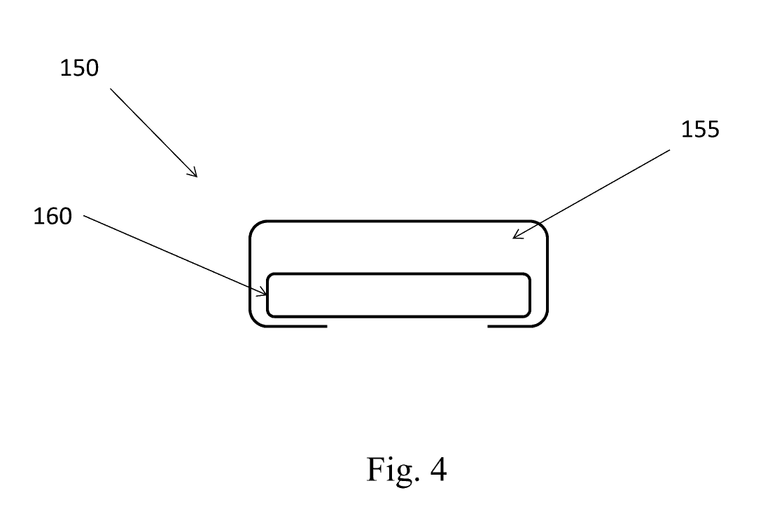

FIG. 4 illustrates an end view of the support rail 150. As shown, the support rail 150 defines an internal track 155 having a generally C-shaped cross section. The wheel 160 is able to translate along the length of the internal track 155.

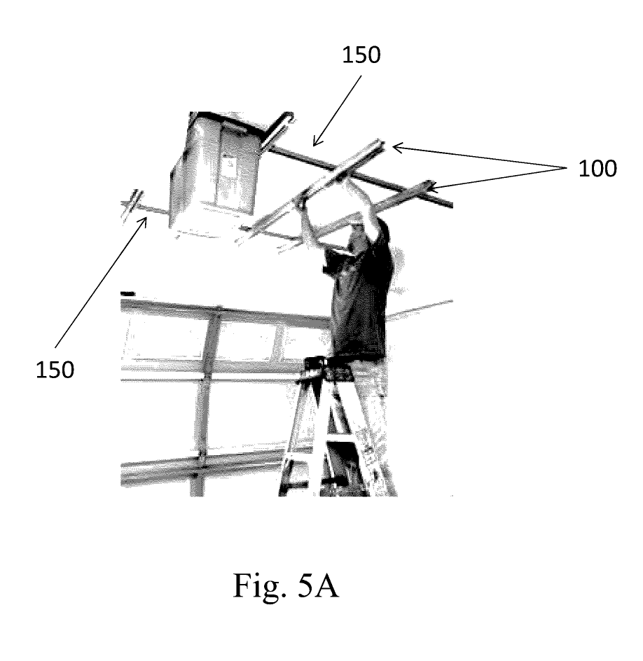

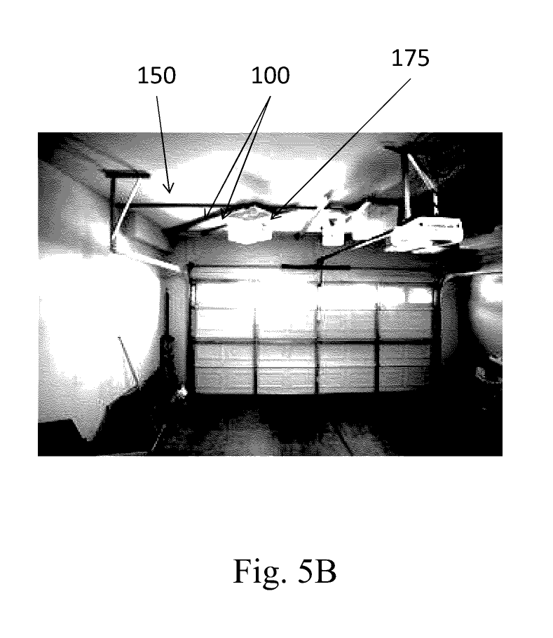

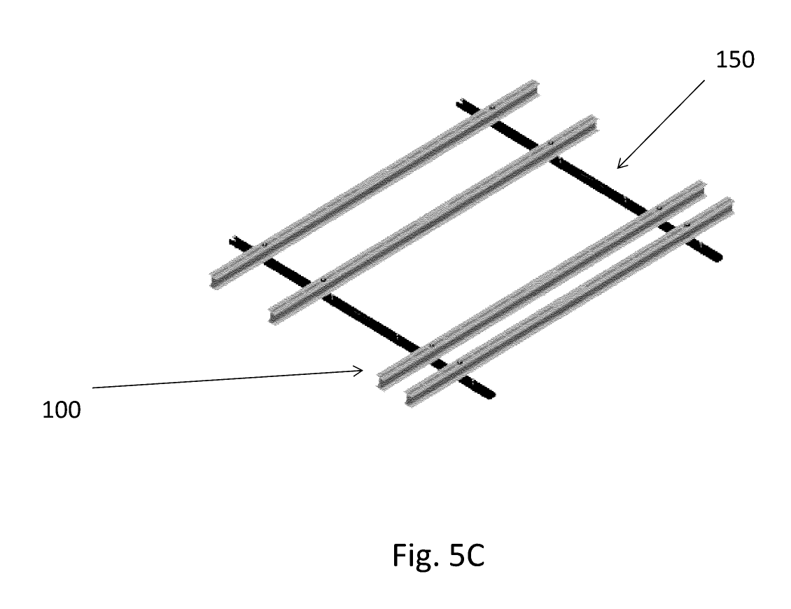

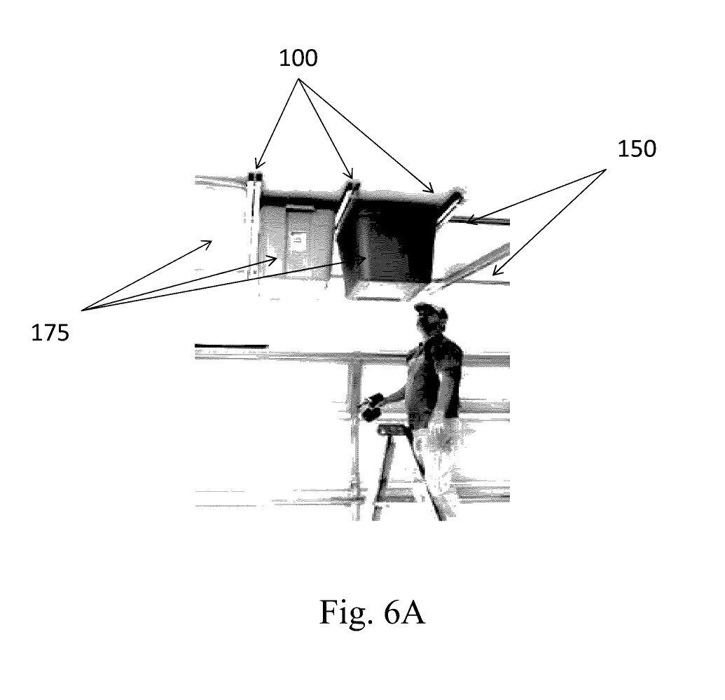

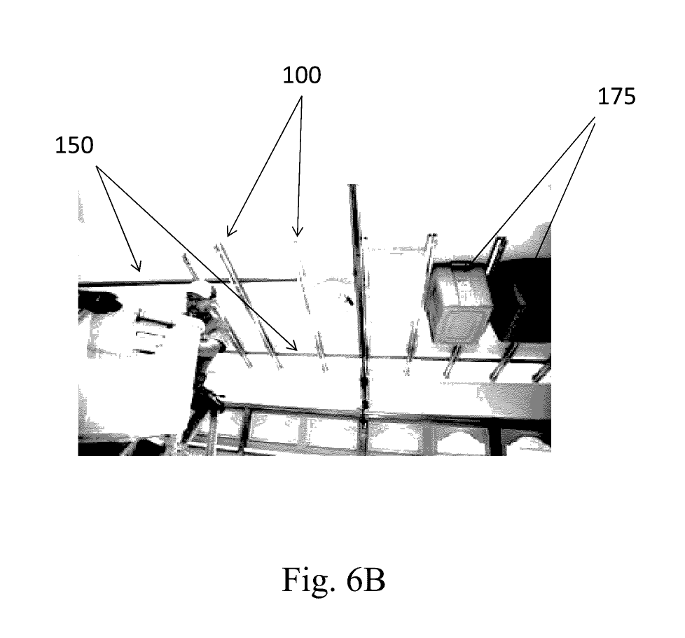

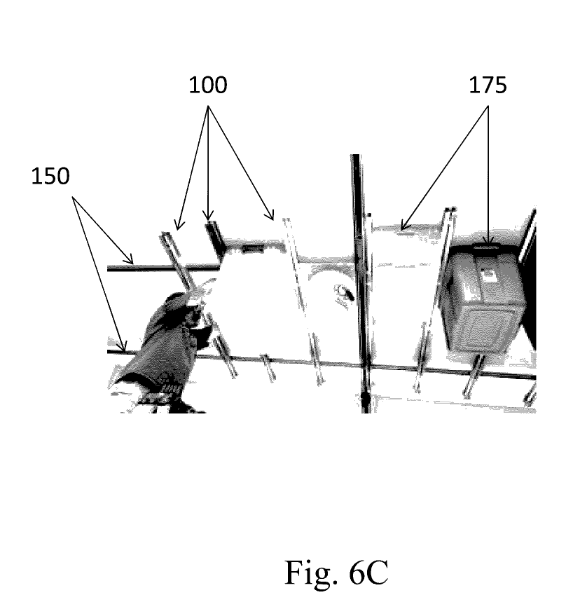

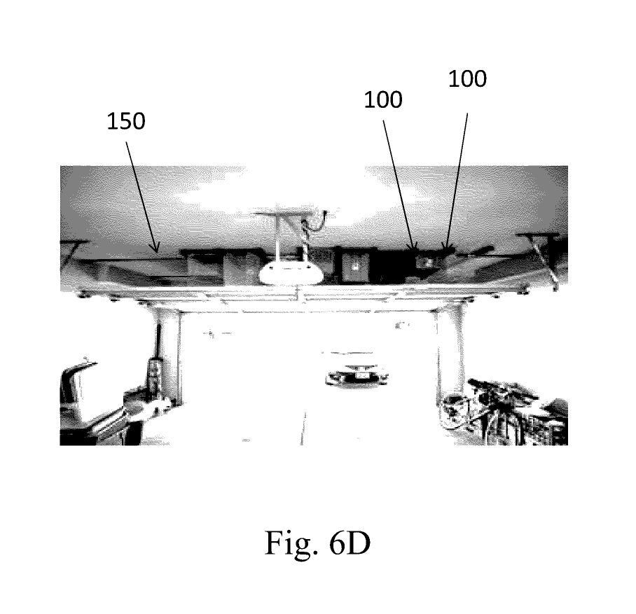

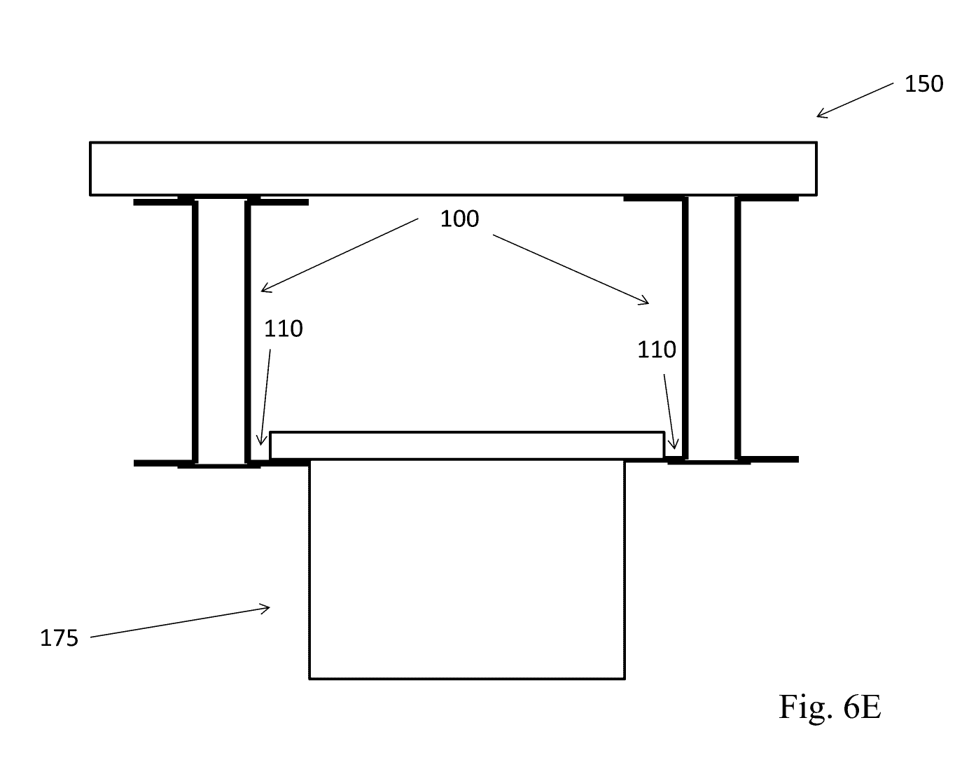

FIGS. 5A-5C illustrate storage unit receiving track members 100 movably attached to support rails 150 according to the embodiments of the present invention. In FIG. 5A, the storage unit receiving track members 100 are movably attached to the support rails 150 in a substantially orthogonal relationship. In FIG. 5B, the storage unit receiving track members 100 are movably attached to the support rails 150 in an angled relationship. FIGS. 6A-6D show various storage units 175 hanging from the storage unit receiving track members 100. FIG. 6E shows an end view of a storage container 175 hanging from a pair of storage unit receiving track members 100.

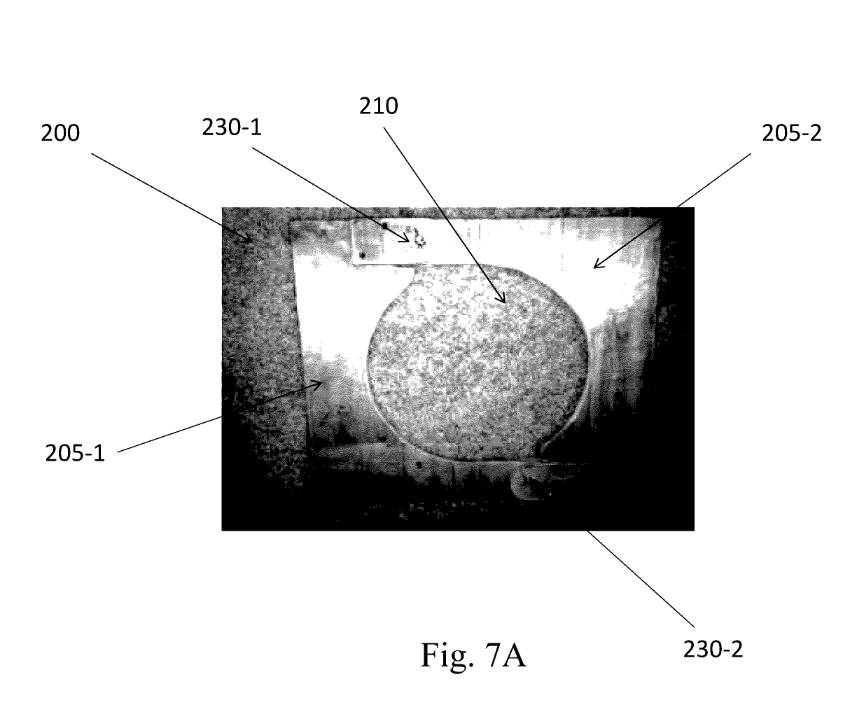

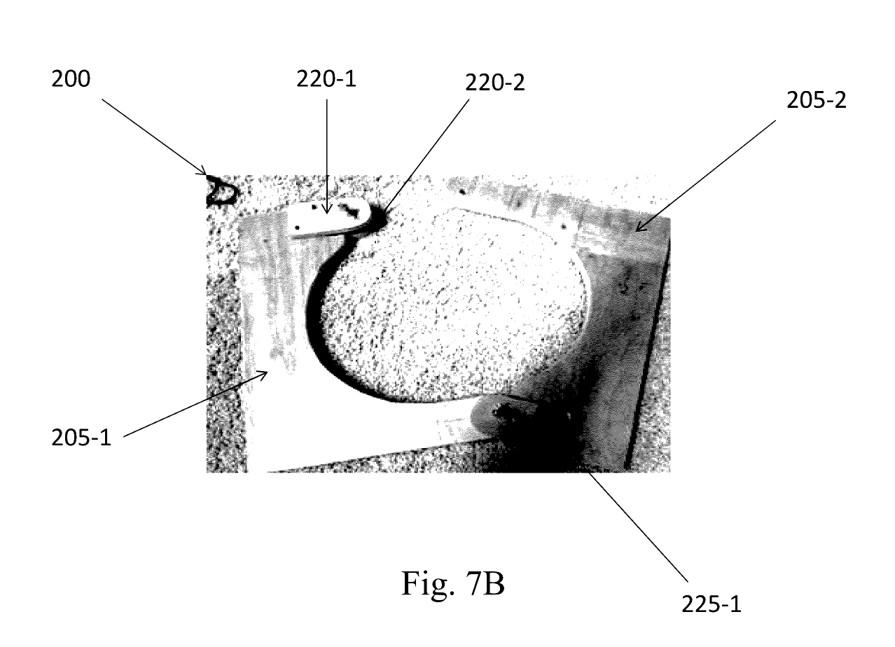

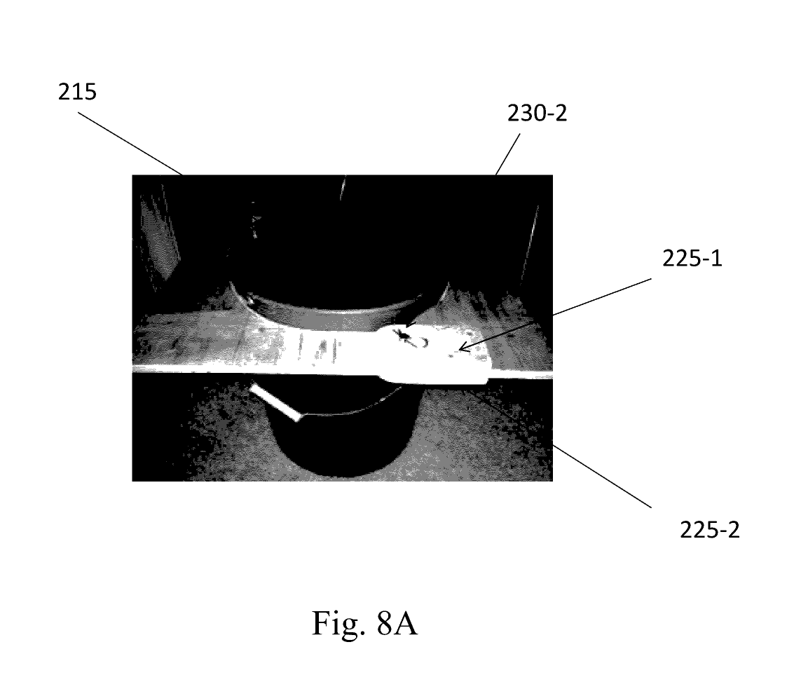

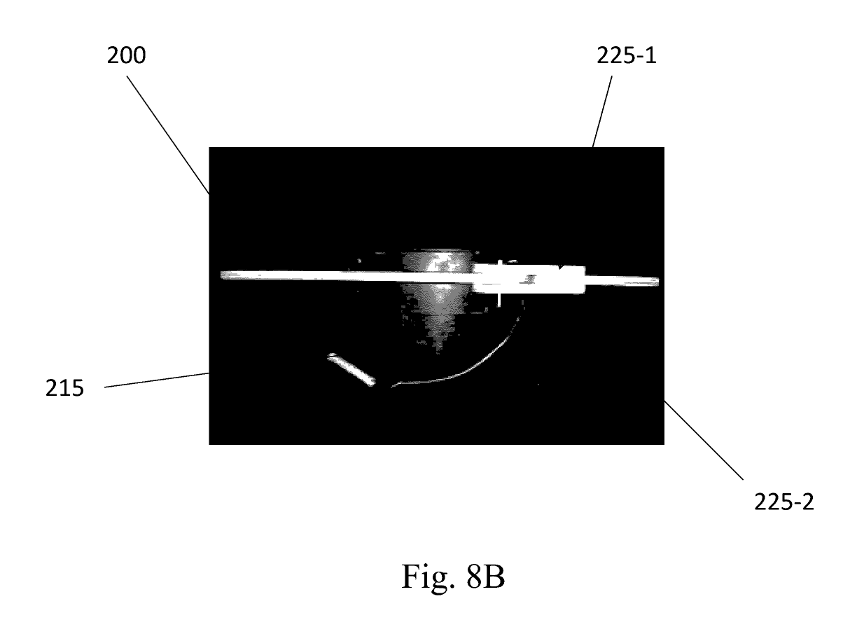

FIGS. 7A and 7B illustrate a bucket receiving member 200 in closed and open positions, respectively, according to the embodiments of the present invention. The bucket receiving member 200 includes two generally identical leafs 205-1 and 205-2 which when connected define a circular opening 210. In other embodiments, the two leafs may be any two paired parts (identical or not) which define a circular opening. The circular opening 210 is dimensioned to receive and retain a bucket 215 as shown in FIGS. 8A and 8B. Buckets of all sizes, including 1 to 10 gallon types may be attached using the bucket receiving member 200.

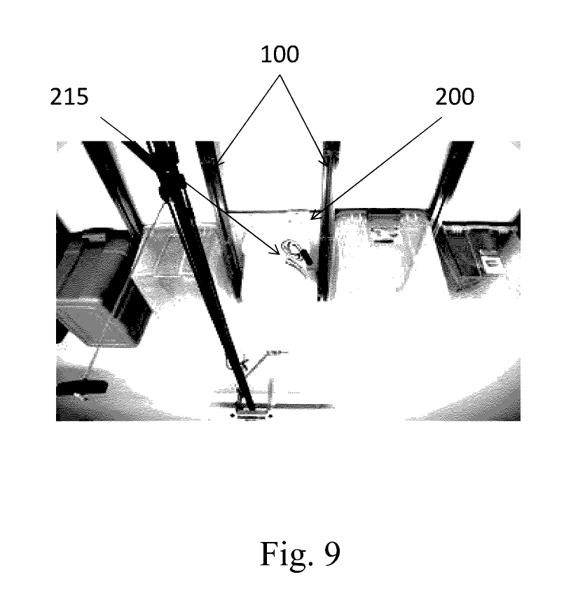

In one embodiment, the two leafs 205-1 and 205-2 are joined to one another at two locations via common fasteners. As shown, a first pair of block members 220-1 and 220-2 and second pair of block members 225-1 and 225-2 are positioned on the first leaf 205-1 and second leaf 205-2, respectively, to accept an end portion of an opposite leaf. As shown, one of the block members 220-1 is attached to one side of the leaf 205-1 while the other block member 220-2 is attached to an opposite side of the block member 220-2. The same arrangement is true for leaf 205-2 and block members 225-1 and 225-2. The two connection points permit the bucket receiving member 200 to open and close as detailed below. In one embodiment, bolt and cotter pin combinations 230-1 and 230-2 join the two leafs 205-1, 205-2 to one another via the block members 220-1, 220-2, 225-1 and 225-2. Use of the bucket receiving member 200 involves disengaging one bolt and cotter pin combination allowing the two leafs 205-1 and 205-2 to rotate into an open position relative to each other about the opposite bolt and cotter pin combination thereby permitting the bucket receiving member 200 to clamp about one of the circumferential ridges proximate to the top of the bucket 215. Once the bucket 215 is positioned within the circular opening 210, the two leafs 205-1, 205-2 are closed and the bolt and cotter pin engaged to retain the bucket 215. FIG. 9 illustrates the bucket receiving member 200 inserted into the storage unit receiving track members 100.

In another embodiment, the block members may be attached to the same leaf as long as one leaf may be rotated about the other. The bucket receiving member may also be fabricated without the block members. For example, the leafs may be attached to one another directly using fasteners allowing rotation about one connection point when the other connection point is disengaged.

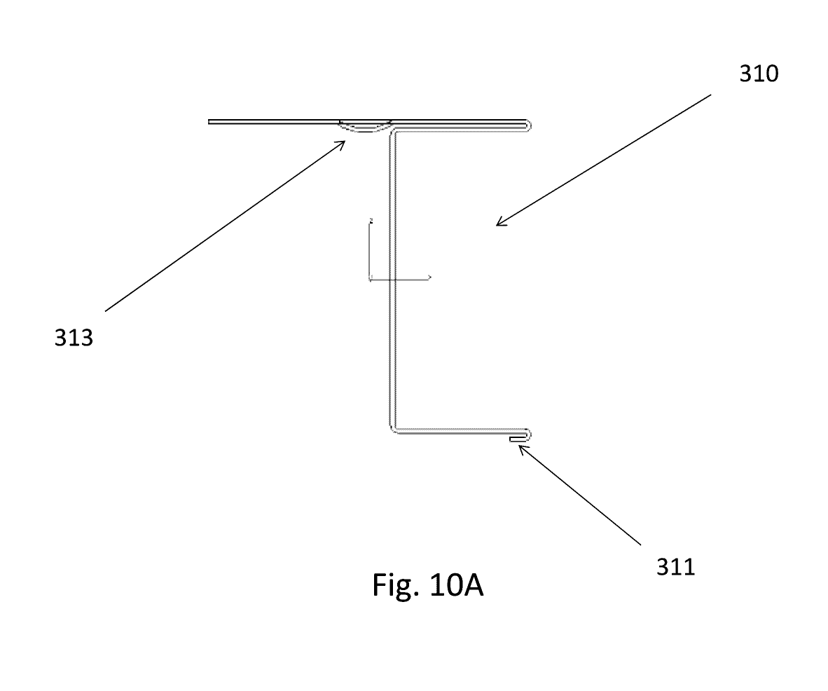

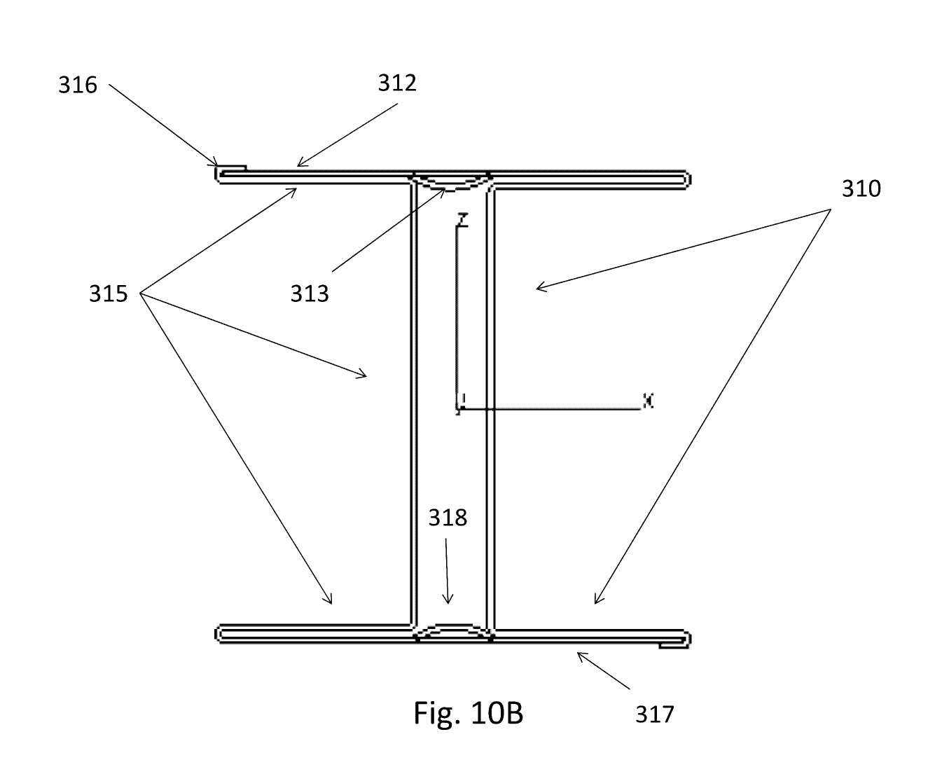

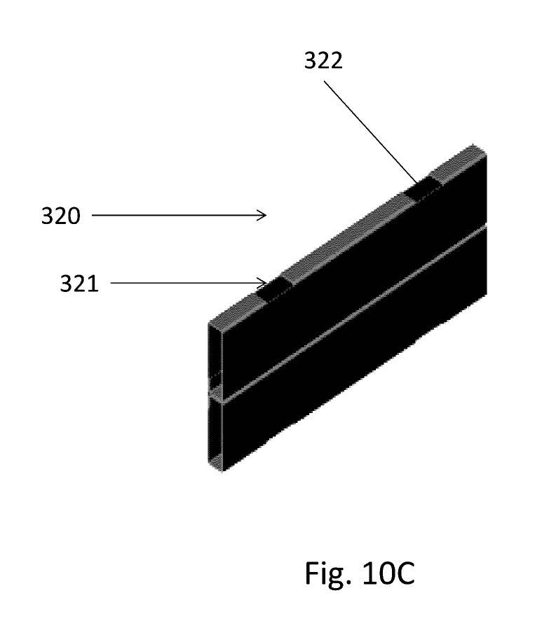

FIGS. 10A-10C show an alternative embodiment of a storage unit receiving track member 300 comprising three separate members according to the embodiments of the present invention. FIGS. 10A and 10B show ends of two elongated half members 310, 315 that join to form the I-shaped storage unit receiving track member 300. Half member 310 takes a generally T-shape while half member 315 takes a generally upside T-shape. The two half members 310, 315 mate via a pair of loops 311, 316 which receive a straight member 312, 317 of the opposite half member 310, 315. A splice member 320 may be used to further secure the two half members 310, 315. Spaced indents 313, 318 are positioned to insert into spaced openings 321, 322 in the splice member 320. In this embodiment, the storage unit receiving track member 300 is less burdensome to transport as it may be disassembled and reassembled easily.

Although the invention has been described in detail with reference to several embodiments, additional variations and modifications exist within the scope and spirit of the invention as described and defined in the following claims.

I claim:

1. A system comprising:
at least two support rails attachable to an overhead member; and
at least two storage unit receiving track members configured to movably attach to said at least two support rails in a spaced relationship, said at least two storage unit receiving track members each having a side ledge configured to receive and support an opposite upper portion of one or more storage units comprising a container and lid member wherein said opposite upper portions extend into oppositely facing side ledges of said at least two storage unit track members when movably attached to said at least two support rails.

2. The system of claim 1 wherein said at least two storage unit receiving track members have an I-shaped cross-section.

3. The system of claim 1 further comprising multiple movable roller mechanisms inserted in said at least two support rails, said movable wheels configured to receive a fastener for attachment of said at least two storage unit receiving track members.

4. The system of claim 1 wherein said at least two support rails have a C-shaped cross section.

5. The system of claim 1 further comprising a bucket receiving member configured to receive and retain a bucket.

6. The system of claim 1 wherein said at least two storage unit receiving track members are further configured to slidably attach to said at least two support rails such that a distance between said at least two storage unit receiving track members may be adjusted to accommodate storage units of varied sizes.

7. The system of claim 2 wherein said at least two storage unit receiving track members are formed of two half members configured to attach to one another.

8. A system comprising:
a plurality of support rails attachable to an overhead structure;
a plurality of storage unit receiving track members configured to slidably attach to at least two of said plurality of two support rails, each storage unit receiving track members having an I-shaped cross section with lower ledges for receiving and supporting upper portions of one or more storage units comprising a container and lid member wherein opposite upper portions extend into oppositely facing lower ledges of said storage unit track members when movably attached to at least two support rails.

9. The system of claim 8 wherein said plurality of said storage unit receiving track members have an I-shaped cross-section.

10. The system of claim 8 further comprising multiple movable roller mechanisms inserted in said at least two support rails, said movable wheels configured to receive a fastener for attachment of said plurality of said storage unit receiving track members.

11. The system of claim 8 wherein said support rails have a C-shaped cross section.

12. The system of claim 8 further comprising a bucket receiving member configured to receive and retain a bucket.

13. The system of claim 9 wherein said at least two storage unit receiving track members are formed of two half members configured to attach to one another.

14. A system comprising:
at least two support rails attachable to an overhead member;
at least two storage unit receiving track members configured to movably attach to said at least two support rails, said at least two storage unit receiving track members each having a side ledge configured to receive and support an opposite upper portions of one or more storage units comprising a container and lid member wherein opposite upper portions extend into oppositely facing side ledges of said at least two storage unit track members when movably attached to said at least two support rails; and
one or more bucket receiving members configured to retain a bucket and slide along opposite facing side ledges of neighboring storage unit receiving track members.

15. The system of claim 14 wherein said at least two storage unit receiving track members have an I-shaped cross-section.

16. The system of claim 14 further comprising multiple movable roller mechanisms inserted in said at least two support rails, said movable wheels configured to receive a fastener for attachment of said at least two storage unit receiving track members.

17. The system of claim 14 wherein said at least two support rails have a C-shaped cross section.

18. The system of claim 14 further comprising a bucket receiving member configured to receive and retain a bucket.

19. The system of claim 14 wherein said at least two storage unit receiving track members are further configured to slidably attach to said at least two support rails such that a distance between said at least two storage unit receiving track members may be adjusted to accommodate storage units of varied sizes.

20. The system of claim 15 wherein said at least two storage unit receiving track members are formed of two half members configured to attach to one another.

21. A bucket receiving member comprising:
first and second leaf members which when joined define a circular opening; and
said first and second leaf members connected to one another about two connection points whereby one connection point may be disengaged such that the leaf members may be rotated relative to each other about the other connection point to open said circular opening for receipt of a bucket.

22. The bucket receiving member of claim 21 further comprising a pair of block members attached to each of said leaf members, said block members defining a space for receipt of the other leaf members.
